(19) United States
(12) Patent Application Publication
(10) Pub. No.: US 2022/0111414 A1
(43) Pub. Date: Apr. 14, 2022

(54) COLORING OF LEAD OR STEEL HUNTING/SPORTING SHOTS AND ITS METHOD

(71) Applicant: HEPER METAL DOKUM SAN. VE TIC. A.S., Torbali, Izmir (TR)

(72) Inventor: Hasan YAVAS, Narlidere, Izmir (TR)

(21) Appl. No.: 17/428,499

(22) PCT Filed: Dec. 25, 2019
(86) PCT No.: PCT/TR2019/051211

§ 371 Date: Aug. 4, 2021

(51) Int. Cl. B05D 1/02; F42B 7/04; B05D 3/10; B05D 3/04

(52) U.S. Cl. CPC B05D 1/02; B05D 3/0426; B05D 3/102; F42B 7/046

(57) ABSTRACT

A process of cleaning the surface of lead or steel shot in a drum system and increasing the surface area to allow epoxy to adhere to the surface and spraying and cooking the paint to the surface with a spray gun in the drum system.

### TECHNICAL AREA

The invention relates to a method of coloring of shots manufactured of lead or steel used for hunting or sporting purposes.

### PRIOR ART

The shots are small, round, objects whose main material is lead, used for firing with shotguns: and comprises of a mixture of lead, antimony, and arsenic. Shots are consisting of pure lead are not fully round but soft, so 0.8%-1.5% arsenic is added in this mixture to be fully round. Arsenic prevent moisture of lead, it makes the outer surface stronger and facilitates its casting, ie drop formation, and also hardens the shots. For hardening of the shot, 1%-5% of antimony is added to this mixture. This ratio may very rarely be higher, as the antimony additive increases, the shot becomes harder, and the density of the shot gets lower and not full-round during casting, so the rate of output of the shot is lower. We consider that the antimony added shots are harsh, so more effective shots can be made with antimony shots, the lead shots become more robust and the distribution is better. However, their costs are high and they may harm to hydrophilic environments.

Today, the shot used for hunting and sporting purposes are made by manual methods or automation. In addition, the shot is again divided into two, as alloyed shot and other metal alloyed shot. Lead alloy shots are made of lead and the other metal alloyed shot are made of steel and similar materials.

Lead alloy lead shots:

Manually manufactured Ishots are generally produced made by a method, using simpler and older methods to meet the end user's own needs. In this method, the user places the lead in an iron hollow container and melts the lead by giving heat from below. The molten lead falls from the hole in the bottom of the container into a container filled with water. Lead drops drop by drop into the container filled with water become round and harden again in the water.

There is no coating or additional process in this method. The lead itself is completely used as shot.

It is the person who melts the lead ingot in the furnace and adds a certain amount of arsenic into the melt and takes it with scoops from the melt in order to produce shot for sporting purposes.

In factory areas, tower casting technique is generally used. Although lead melting and pouring (cartridge shots) procedures are made in line with the general operating principles of the enterprise, using tools and equipment in an effective way.

Nowadays, the steps of these commonly used method are as follows; Instruct the personnel called lifter to take the materials to the tower,

Light the stove up and controlling the temperature from the indicators,

Throw the lead ingot to be melted into the furnace, load using the necessary lifting and handling equipment and wait for a certain time for the lead to melt,

Monitor the heat status of the standby furnace from indicators,

If necessary, add a certain amount of arsenic lead into the molten lead, by making adjustments in temperature,

Wait for the mixture to reach a casting consistency,

In some factories, this method is also done with automation by taking the melt from the casting consistency with a ladle and pouring it into the sheet sieve, which is put on the shot casting pipe.

Proceed the procedure in the same way,

According to the size of the shot to be manufactured to change sheet sieves and similar tasks and operations are performed.

Briefly, the production of shot up to 4 mm in size is usually done in the (classical way) casting procedure.

During this process, the molten lead mixture is poured into metal sieves from high towers from 50 m to 100 m. These sieves are placed on the water pools. During this long drop, droplets of lead fall into the water in round shapes with the help of arsenic, and they remain cooled in water. Although the diameter of the shots is the same, as the holes of the metal sieve, they are very close to each other but they are not the same, because are separated for this. The smooth ones are removed and thrown into a hood with graphite and the hood is rotated. This is the last stage of the process. In this way, the shot is protected from acidification, less friction is provided in the barrel, and they get more uniform appearance.

In addition to this, there are also more advanced methods. For the shots with diameters bigger than 4 mm, lead is drawn into the form of wire and cut with half-moon blades. This results in very uniform shots, which are then graphitized. In some countries the shots are coated with nickel, today they are the best quality and well-distributed and are often used in competitions. Smoothness and roundness of the shots is important for the distribution. For example, when an oval, pear-shaped shots get out of the barrel, it will disperse other shots and the shot distribution will be destroyed. shots are produced in different countries with different numbers and signs.

Other Metal Alloy Shot Group:

In the last years, lead shot balls manufactured of steel are also used. Today, many companies and institutions demand lead shot/lead ball in various forms. There is a demand for lead shot/lead ball in a wide area, from the hobby sector to the furniture industry, from the companies that produce kitchen appliances to the companies that produce lifts. It is also called lead shot/lead ball, which are requested. The most important reason of all these demands, is the great resistance of the lead shot/lead ball against friction. Since different chemical components are also used in the production of balls, a wide product portfolio is produced in terms of resistance pressure points with different mechanical properties and different modulus of force and elasticity. Lead shots manufacturing of steel is made for hunting and sporting purposes. These are considered as:

Bismuth alloy shots

Soft Steel shots

Soft Composites shots

Hard Composites shots

In the Lead Alloy shot group, for environmental reasons, in some countries waterfowl prohibited shots contain up to 5% antimony, whereas in large ones it is up to 3%. It is aimed to give hardness to the lead shots by adding this material. As is commonly known in ballistics, hard shots form a much better pattern of shots. Lead shots are usually offered in the production of cartridges by coating copper or nickel.

Of the Other Metal Alloy Lead shot groups, Bismuth, the main metal of Bismuth alloy lead shots, has a density of 83% of lead as a metal. In order to reduce the destructive effect of the barrel and shock, bismuth is produced in alloy with 2% cobalt, as a cartridge lead shot. Lead is more expensive than shots. Unlike steel shots, they do not require very high strength shocks and can be filled with normal lead shot plugs.

Steel; Soft steel shots from the group of shots are the most economical non-toxic alternative to lead shots. Steel metal, of course, requires special and high-density plastic plugs, as well as steel shots with high resistance to shocks and barrels. They are coated with copper, nickel or zinc to prevent corrosion.

The soft composites of the other metal alloy shots group are composed of a mixture of powdered metals such as copper, tin, iron and tungsten in polymer binders. These shots can be used in combination with normal shot plugs and do not require a high-density plug or special hardened high-strength shocks. The intensity of these shots is as high as shots, but they are expensive.

Hard composites, which are another other metal alloy shots, are made from powdered copper, iron, steel, tungsten and tin stamped into the mold. While the intensity of these shots is at least as high as lead shots, many have a density above the intensity of lead shots. However, these lead shots are very expensive. It is used with hard compound shots, special steel shot plugs and special shocks with high resistance to hardened steel.

In addition to the above, there are other substances that have been tried so far to be used in the production of lead shots but have not succeeded as lead shot alone, these are: zinc, copper (expensive), tin (expensive), plastic (very light) and tungsten (hard and expensive).

In addition, the dense rubber material is also used in the production of special lead shots that does not kill and slug ammunition.

With respect to the epoxy-containing method, which is relevant to our invention, the need for mentioning the prior art with respect to epoxy paint has also arisen. Epoxy paint is a chemical resin. After drying, it becomes highly resistant to all physical and chemical effects. It is mostly used in floor covering because of its easy shape and chic appearance. We can see epoxy paint applications on table, floor and many decoration tools.

Besides being a solid material, epoxy paint provides a great convenience in reflecting the desired design on the ground due to its shape. There are different application methods for epoxy coating processes depending on each product or situation.

At the same time, epoxy paint is frequently seen in the flooring of hospitals and schools, because it is an easy and rapid application. Shortly, epoxy, which has a very wide application area, has never been used for hunting and sporting ammunition such as leads and bullets. Furthermore, the present techniques generally include spray coating for larger and flat areas.

As a result of our research, the file No 2014/05491 for a shot production method, has been reached. The invention includes a pellet for a sports rifle or a sports gun, an articulated object and a tip. The lower portion of the body includes a first inner cavity and a head of the body includes a second inner cavity. The tip includes an upper portion and a lower portion on at least one peak end, the upper and lower portions are being combined at their bases. The lower part of the tip is moved into the second inner cavity. A portion of the head may be bent around the tip to hold the tip within the second internal cavity of the body. An outer ring may be formed at the tip, and the curled portion of the head relates to a curable projectile projection on the pulley to securely hold the tip in the body.

Another invention is US2018156588 A lead-free, non-toxic bullet for air gun BB, lump or slingshots, which disintegrates into small pieces or fragments when striking a hard surface. A method for producing the bullet of the present invention is also disclosed.

Another invention is WO2016100440, and generally relates to the steel compositions, manufacturing of compositions and the use of compositions to produce edge fire ammunition cartridges. Steel compositions for use in edge firing cartridges are processed by cold rolling and annealing steps to create suitable physical properties.

After our research on epoxy coating, application No CN108977807 was found. The invention discloses a steel plate surface environmentally friendly corrosion prevention method comprising the following steps: surface cleaning and drying on a steel plate to be processed; chemical copper plating to form a metal copper layer on the surface of the steel plate; sandblasting; providing epoxy resin, a curing material, an anionic surfactant, and carbon nanotubes; and mixing epoxy resin, curing material, anionic surfactant, and carbon nanotubes; mixing on a mixture A to obtain a homogeneously dispersed epoxy resin solution; brushing the uniformly dispersed epoxy resin solution onto the steel plate exposed to the spray gun and the surface of which is coated with a metal copper layer and curing to obtain a laminate A; placing a layer of Si on the surface of laminate A; mixing the phenolic resin, the curing agent, the anionic surfactant and the carbon nanotubes to obtain a mixture B; Mixing B mixture to obtain a homogeneously dispersed phenolic resin solution; brushing the uniformly dispersed phenolic resin solution onto the laminate A surface where the surface is coated with Si layer.

Another invention No CN108943942, the invention discloses a method of preparing an environmentally friendly, high performance composite material doorplate. The preparation method includes the following steps: 1) coating both sides of the sandwich material with epoxy adhesive; 2) placing a thermoplastic damping agent on both sides of the sandwich material; 3) continuous fiber preparation on the surfaces of the thermoplastic damping material to obtain a multilayer laminated body; and 4) placing the multilayer laminated body in a mold, then placing the laminated body in a press machine after the mold is closed and lamination at a temperature of 100-150° C. for 1-3 hours, the composite material door plate has the advantages of light weight, high strength, excellent sound insulation performance, excellent bullet proof performance and no formaldehyde release. The mass of the door plate is greatly reduced by the foam in the sandwich material and the gaps in the foam serve as a good sound insulation.

The thermoplastic damping material polyvinyl butyral (PVB) and ethylene-vinyl acetate (EVA) have excellent damping performance and have impact and bulletproof properties to greatly increase the safety of the door plate. Formaldehyde-type adhesive is not required in a utilization process and formaldehyde is not released during the use of a product, so the method of preparation relates to being safe and environmentally friendly.

None of the relevant inventions is intended for lead shots/lead balls. It is therefore evident that the use of existing products in particular is detrimental to nature. Because lead-containing products are not easily destroyed in nature, they also cause harm. Lead shots used for hunting and sporting are dissolved in a while after being released to nature and cause heavy metals to accumulate in soil and water.

However, the above-mentioned existing products are either very expensive or not suitable for use as shots. Most non-toxic products have a high cost. The use of lead alloy products which have a low-cost are inefficient due to their light weight.

### PURPOSE OF THE INVENTION

The present invention relates to a method of coloring and producing lead or steel hunting and sporting lead shots which meet the above-mentioned requirements, eliminate all disadvantages and bring some additional advantages.

The main object of the invention is to provide long-term durability and strength in all kinds of lead shots in any usage with the of epoxy coating method of lead or steel shots.

Another object is to paint lead or steel shots with epoxy paint in the drum system and to eliminate environmental damage by cutting contact of the lead with the external environment.

Another object is to reduce the frictional effect of the ball during the shot by achieving an even smoother surface with epoxy coating of lead or steel shots.

Another object is the additional hardness imparted to lead and steel shots by means of epoxy coating, so that the shot can advance to the target after the ball is dispersed.

Another object of the invention is to provide coloring according to the demand of the consumer. Thus, the balls become visible during the shot because they are colored.

Another object is to absorb the lead element gas which is produced by epoxy coating during production. In this way, production personnel are prevented from being negatively affected during production.

### FIGURES TO HELP UNDERSTANDING OF THE INVENTION

In order to better understand the advantages and embodiment of the present invention in conjunction with the additional elements of the present invention, it should be considered together with the figures described below.

FIG. 1: The cross-sectional perspective view of the process of coloring and producing lead or steel shots with epoxy for hunting and sporting according to the invention.

The drawings do not necessarily have to be scaled and the details that are not necessary to understand the present invention may be omitted. Apart from this, the elements which are at least substantially identical or have at least substantially identical functions been indicated by the same number.

### PART REFERENCES

10. shot

10. epoxy

### DETAILED DESCRIPTION OF THE INVENTION

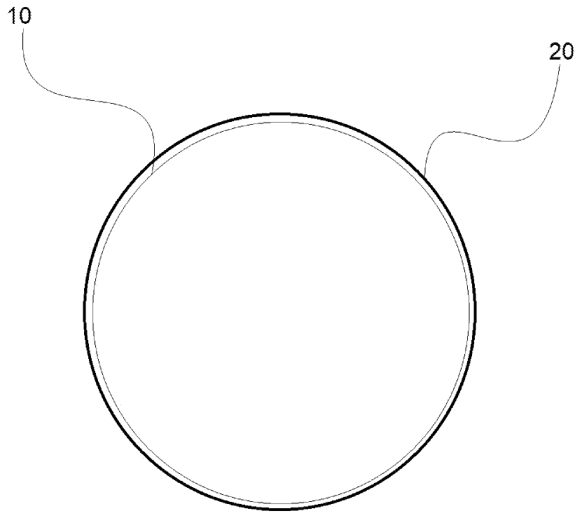

FIG. 1 shows the cross-sectional perspective view of the process of coloring and producing lead or steel shots with epoxy for hunting and sporting according to the invention.

Epoxy (20) is an adhesive chemical resin which is applied as a liquid and does not lose its resistance in time, which becomes resistant to water, acids and alkali after drying, is easy to clean, has high mechanical strength and is used in many areas.

Properties of epoxy (20);

1—It is aesthetic,

2—Creates surfaces resistant to friction and abrasion,

3—Easy to clean, hygienic,

4—It is extremely resistant to many chemical effects such as basic and heavy loads such as physical and acidic.

5—Solvent-free,

6—Skidproof,

7—Odorless,

8—Easy and fast to apply,

9—Waterproof,

10—Provides high mechanical resistance,

11—Does not harm human health,

12—It is a long-lasting and durable coating.

By using these properties, it is provided to prevent damage to nature after coloring of lead or steel shots (10) with epoxy (20) paint.

In addition, long-term durability and strength in all kind of shots (10) by means of epoxy (20) coating of lead or steel shots is provided.

Additional hardness imparted to lead and steel shots by means of epoxy coating is made, so that the shot can advance to the target after the ball is dispersed.

By providing an even smoother surface of the lead or steel shots (10) with the epoxy (20) coating, the frictional effect of the shots (10) during the shot is reduced.

FIG. 2 shows a table view of the production stage of the method of coloring and producing lead or steel shots with epoxy for hunting and sporting according to the invention. Pretreatments are carried out on lead or steel shots (10) and the processes of painting with epoxy (20) paint are summarized.

Process Steps:

Graphite cleaning is carried out with the appropriate chemical with the vibration device of lead or steel shot (10) (A)

In the next step, it starts with the washing process and the cleaning of this chemical. (B)

In the next step, the surface area of the shot (10) is increased for the adhesion of the paint by the crystallization of the surface by chromatography.

In the next step, the chemical bath of the acidic chromatography bath is removed from the surface of the lead shot (10) by washing (G).

In the next step, water is removed from the surface by drying process and epoxy (20) paint is adhered to the surface of the shot (10) (C).

In the next step, the shots (10) is taken into the drum is first heated up to 90°, and the dyeing process is started by mixing the colored epoxy (20) paint+hardener+thinner chemicals which are put into the paint chamber of the spray gun in certain proportions (D). The paint on the interface is checked visually.

In the next step, a transparent chemical is added to the spray gun paint chamber to ensure polishing when the coating is completed. In case there is no dye remaining in the tank, epoxy (20) dye+hardener+thinner+transparent chemical mixture is prepared and taken into the chamber and a dyeing process is performed again (E).

In the next step, if the brightness is suitable after the visual control, the cooking process is performed and the adhesion of the epoxy (20) paint to the surface of the shots (10) is completed (F).

In the next step, in order to carry out the quality control and packaging of the cooked paint, the materials are placed in special pans and cooling is performed with fan (G).

In the next step, the colored product is packaged by performing visual quality control.

1. A method of coating of lead or steel shot with epoxy, comprising the steps of:
carrying out graphite cleaning with an appropriate chemical with a vibration device of lead or steel shot;
starting with a washing process and cleaning of the chemical;
removing water from the surface by drying process and providing that the epoxy paint is adhered to the surface of the shots;
the lead shot taken into the drum is first heated up to 90°, and the drying process is started by mixing the colored epoxy paint+plus hardener+plus thinner chemicals which are put into a paint chamber of a spray gun in certain proportions;
visually checking the paint on the interface;
a transparent chemical is added to the spray gun paint chamber to ensure polishing when the coating is completed; in case there is no dye remaining in the tank, preparing an epoxy dye+plus hardener+plus thinner+plus transparent chemical mixture and taking into the chamber and a dyeing process is performed again;
if the brightness is suitable after the visual control, performing the cooking process and completing the adhesion of the epoxy paint to the surface of the shots; and
the materials are placed in special pans and cooling is performed with a fan in order to carry out the quality control and packaging of the cooked paint.

2. Lead or steel shot coating with epoxy according to claim 1, wherein it has a property to prevent harm to the nature after coloring lead or steel shot with epoxy paint.

3. Lead or steel shot coating with epoxy according to claim 1, wherein the long-term durability and strength in all kinds of shots by means of epoxy coating of lead or steel shots is provided.

4. Lead or steel shot coating with epoxy according to claim 1, wherein additional hardness imparted to lead and steel shots by means of epoxy coating is made, so that the shots can advance to the target after the ball is dispersed.

5. Lead or steel shot coating with epoxy according to claim 1, wherein by providing an even smoother surface of the lead or lead shots with the epoxy coating, the frictional effect of the shots during the shot is reduced.
